(19) United States
(12) Patent Application Publication
(10) Pub. No.: US 2016/0227713 A1
(43) Pub. Date: Aug. 11, 2016

(54) MESH BASED SYSTEM FOR FLOATING BIO-FILTERS

(71) Applicants: Daniel Haarburger, Boulder, CO (US); Bianca Griffith, Boulder, CO (US)

(72) Inventors: Daniel Haarburger, Boulder, CO (US); Bianca Griffith, Boulder, CO (US)

(21) Appl. No.: 15/042,111

(22) Filed: Feb. 11, 2016

Related U.S. Application Data
(60) Provisional application No. 62/114,747, filed on Feb. 11, 2015.

(51) Int. Cl. A01G 9/10

(52) U.S. Cl. CPC A01G 9/1066; A01G 9/10

(57) ABSTRACT

A planter designed to be inserted into common plastic mesh netting and grow plants which provide bioremediation to polluted bodies of water. The design allows for maximal root exposure, convenient sprouting, and variable installation in the netting. The design also allows for easy mass production and shipment.

### CROSS REFERENCE TO RELATED APPLICATIONS

This application claims the benefit of U.S. Provisional Patent Application No. 62/114,747, filed on Feb. 11, 2015, and titled “Mesh Based System For Floating Bio-Filters” which is incorporated by reference herein in its entirety for all purposes.

### BACKGROUND OF THE INVENTION

1. Field of the Invention

The present invention is in the technical field of Bio-filtration. More particularly, the present invention pertains to the field of a floating mesh that can be used to bio-filter water.

2. Description of Related Art

Current systems for wastewater treatment are lacking in many ways. They are incredibly complex, require the use of dangerous chemicals, and are heavily capital intensive both in terms of initial setup fees and maintenance. These challenges have fueled the search for alternative treatment methods. One such alternative is biofiltration. Floating plants inject oxygen into wastewater tanks, thereby contributing to the aerobic breakdown of the waste by specialized bacteria. For this system to work, the plants must sit atop these filtration pools so that their roots may properly oxygenate the water. For this process to occur, specific situational requirements must be met. It is important to maintain proper spacing among plants so that their root networks might interlink, producing enough surface area for oxygen exchange. The plants must be held in place securely whilst they are in their infancy, but should be able to outgrow their planters over time. The plants should never be fully submerged, though their root structures must always be in water. Further, these plant systems must cover a massive area, measured in the tens to hundreds of thousands of square meters.

Existing planter infrastructure struggles to solve these challenges in a reliable and cost effective manner. Traditional planters consist of many individual planters that are snapped onto thin tubing. While the tubing provides flotation it makes it very difficult to control planter density since the tubing is not rigid and is often installed only in small sections. It is also highly labor intensive to assemble such systems. More innovative solutions involve custom molded planter networks. Here, a series of planters (˜10) are molded into a plastic frame. These frames are then connected together by means of clips on their edges, loaded with plants, and then dragged into the floating pools. The low density of the plastic frames allows them to float on the surface of the ponds while their rigidity keeps them from flipping or unhooking when in place. In these respects molded planters are a great solution. However, the cost of producing these units (both in tooling and per-unit production) makes them prohibitively expensive for many applications.

A better solution would include a number of new features. It would be adaptable in both scale and planter density. It would bridge the plant growing process, which often takes place in a separate facility, with the filtration process. Lastly, and perhaps most importantly, it would be optimized for manufacturing such that the production price would make such a system possible in capital scarce situations.

### SUMMARY

The enclosed embodiment of the invention is an adaptable system for plant-based biofiltration. Rather than molded multi-planter panels, or use connective piping, the design utilizes off the shelf plastic mesh as the planter base. Individual plant-holders (herein referred to as planters) snap into this mesh thanks to flexible wings on their sides. Through this system, large areas can quickly and efficiently be converted into biofilter ponds. At the same time, the expense of these systems is drastically reduced since the mesh can be purchased off the shelf and can utilize pre-existing economies of scale.

Since plastic mesh netting already exists and serves merely as a component in the greater system of this disclosure, the following descriptions will focus primarily on the planters. These planters are independent units that fit directly into the hexagonal cutouts of the plastic mesh. Two wings on each side hook onto the mesh using notched hooks. Meanwhile a cone-shaped extrusion in the middle of the planter provides a home for a plant to grow. This extrusion includes several cutouts on the sides that allow the plant roots to escape the planter as they grow. Meanwhile, a capped base at the bottom of the planter stores soil during incubation so that the plant may be grown in the same planter as it is installed into the mesh network. This design differs significantly from existing biofilter systems in that it doesn't require plants to be uprooted between initial planting (in a greenhouse) and system installation (in the final biofilter system).

To better enable this multi-purpose functionality, one embodiment of the planter is molded in tray groupings. This is advantageous for several reasons. It is often more cost effective to use such groupings because fewer machine cycles are required in mass production. Shipping is often simplified as many units can be easily batched together. Perhaps most importantly, these groups constitute freestanding units that can easily be filled and planted without additional jigs or fixtures.

While connected in a panel, small, perforated lines separate the individual planters. After planting and once the seeds have grown large enough to install in the mesh, individual planters can be detached from the panel and placed into the mesh. They can be added in whatever density best fits the project.

The buoyant material of the plastic and mesh should enable the plants to stay above the waterline (an important requirement for certain species of biofilters) without the need of additional floatation devices. Where additional buoyancy is needed, small life vests can be placed around the central extrusion of each planter. Thus this innovative planter design is able to adjust to a variety of project specific requirements: plant density, buoyancy, pond area, etc. It is also less expensive than the alternatives thanks to its utilization of existing mesh infrastructure and its ability to bridge the plant growing and water filtration phases.

### BRIEF DESCRIPTION OF THE DRAWINGS

The above, and other, aspects, features, and advantages of several embodiments of the present disclosure will be more apparent from the following Detailed Description as presented in conjunction with the following several figures of the Drawing.

### 1. Figures

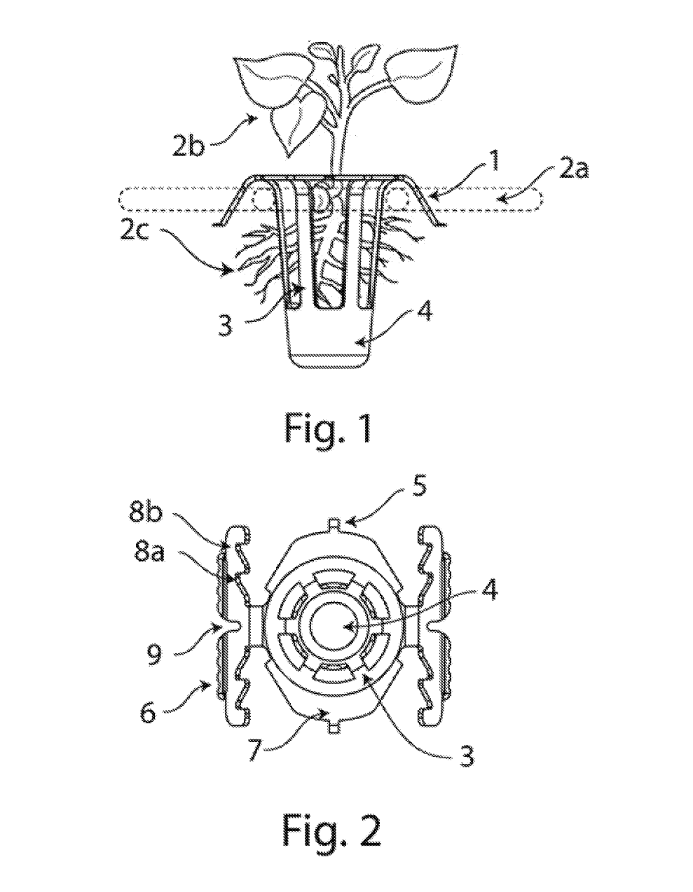

FIG. 1 (Sheet 1) illustrates a front view of an independent planting device, in accordance with an embodiment of the present disclosure.

FIG. 2 (Sheet 1) illustrates a top view of an independent planting device, in accordance with an embodiment of the present disclosure.

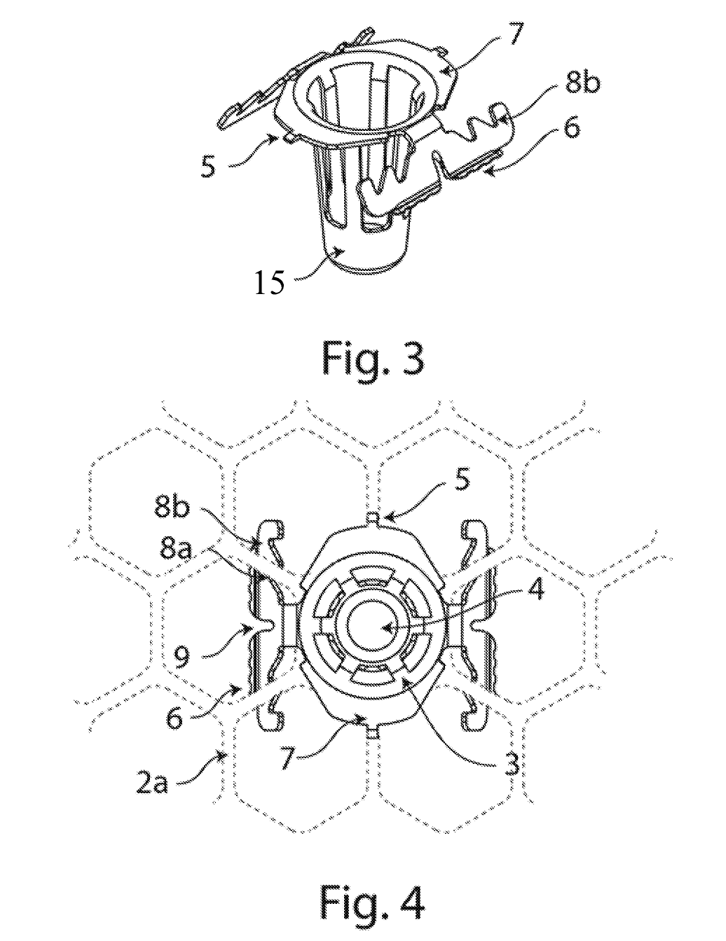

FIG. 3 (Sheet 2) illustrates a perspective view of an independent planting device, in accordance with an embodiment of the present disclosure.

FIG. 4 (Sheet 2) illustrates a top view of an independent planting device as it might appear in a mesh lattice, in accordance with an embodiment of the present disclosure.

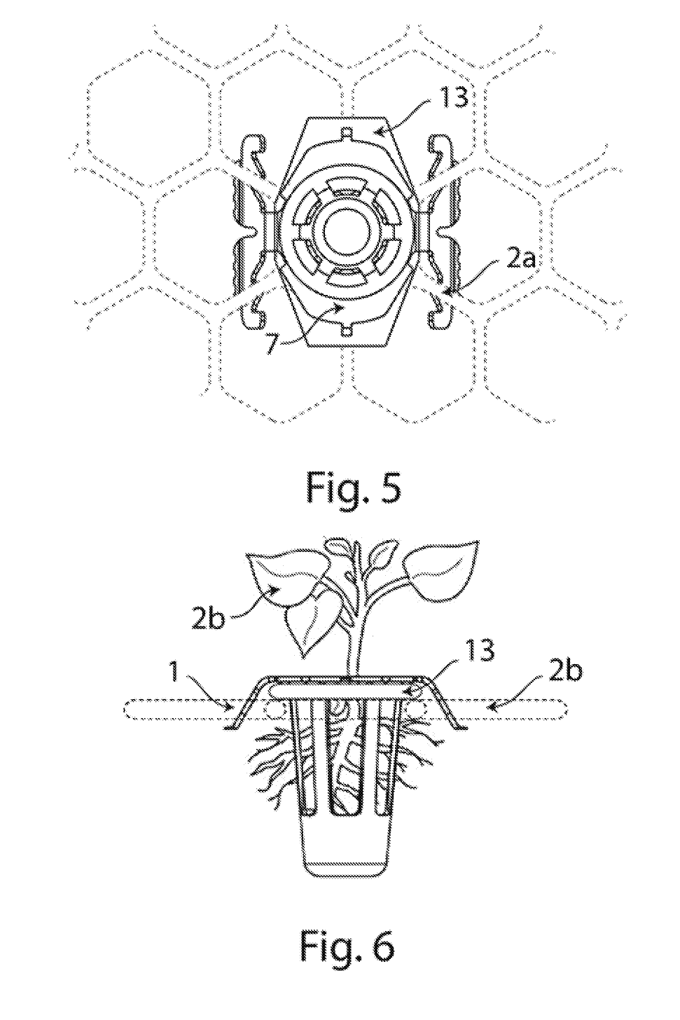

FIG. 5 (Sheet 3) illustrates a top view of an independent planting device as it might appear in a mesh lattice, but illustrating the potential use of a separate flotation device for the planter, in accordance with an embodiment of the present disclosure.

FIG. 6 (Sheet 3) illustrates a side view of an independent planting device as it might appear in a mesh lattice, but illustrating the potential use of a separate flotation device for the planter, in accordance with an embodiment of the present disclosure.

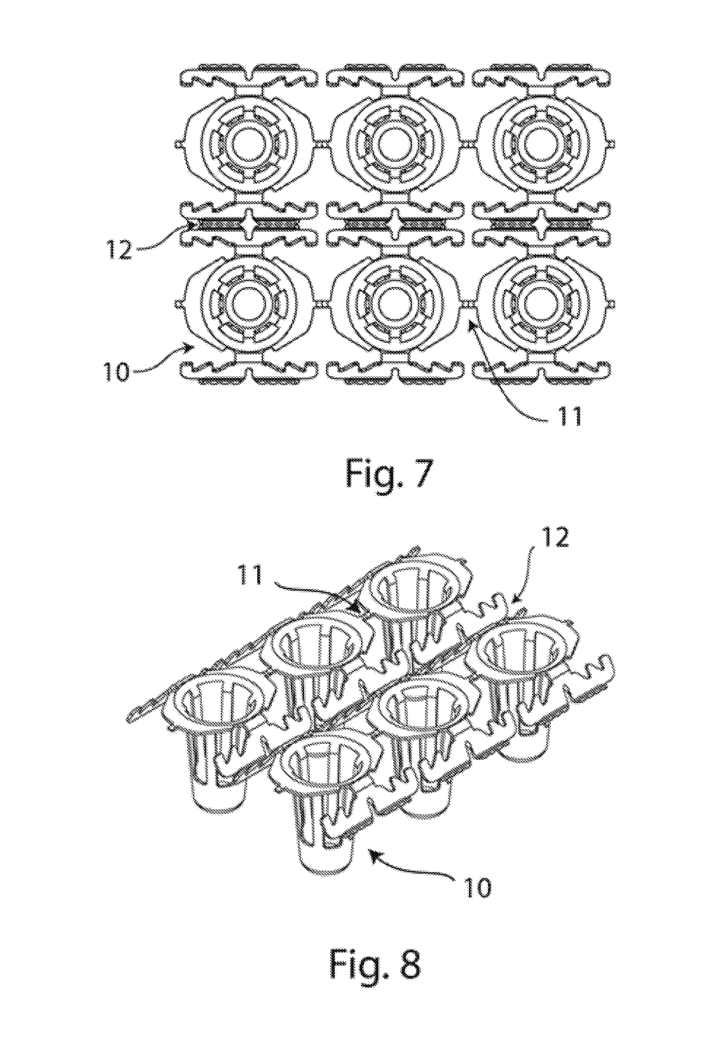

FIG. 7 (Sheet 4) illustrates a top view of a combined panel of individual planters, in accordance with an embodiment of the present disclosure.

FIG. 8 (Sheet 4) illustrates a perspective view of a combined panel of individual planters, in accordance with an embodiment of the present disclosure.

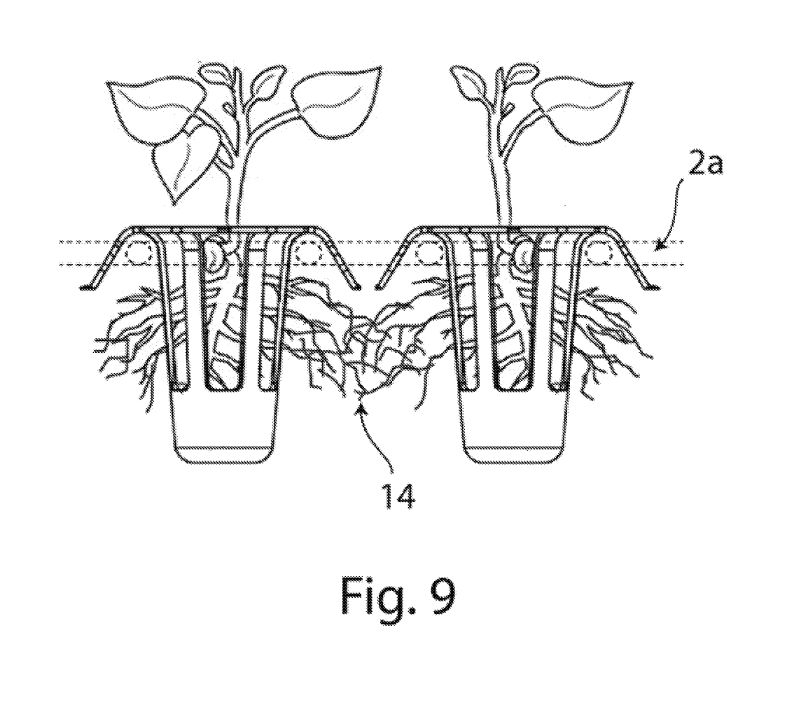

FIG. 9 (Sheet 5) illustrates a front view of two planters depicting the potential for root networks created by co-located plants, in accordance with an embodiment of the present disclosure.

Corresponding reference characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiment are often not depicted in order to facilitate a less obstructed view of these various embodiments of the present disclosure.

### DETAILED DESCRIPTION

The following description is not to be taken in a limiting sense, but is made merely for the purpose of describing the general principles of exemplary embodiments, many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

Unless otherwise indicated, the drawings are intended to be read (e.g., arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

For the purposes of promoting an understanding of the principles of the present invention, reference will now be made to the embodiments illustrated in the drawings and specific language will be used to describe the same.

FIG. 1 illustrates a front view of one embodiment of a planting device. In the diagram, a single buoyant planting device sits atop a layer of mesh 2a, comprising a downward cavity extending from the top of said planter in the middle of the planter 15. This allows the plant's foliage 2b to remain above the water level whilst the roots 2c remain submerged. Here the natural buoyancy of the mesh material provides sufficient flotation to keep the top of the planter and the corresponding plant foliage 2b above water. The planter is held in place by one or more winged extensions 1 that extend through the mesh 2a and attach to it from below. During the planting process and before the planter is installed in the mesh 2a, a base cavity disposed below the top surface of the planter 4 provides a recess for soil in order to grow seedlings. Once large enough, these plants are installed in the mesh for use as biofilters. One or more cutouts 3 in the base cavity 4 provide an opening so the mature plant roots 2c can branch into the water body for better oxygenation.

FIG. 2 is a top, detailed, view of the planter in FIG. 1 depicting in greater details the wings 1 and plant holder. In order to keep the planter from falling through the mesh cutouts, one or more flat panels 7 are molded into the top of the planter. Just as these surfaces prevent the planter from falling below the mesh, wings on each side hook onto the mesh and prevent it from rising too high above it. Bent at an angle to the main planter body, these wings straddle both the top and the bottom of the mesh. On the top, the wings meet the planter body so the mesh cannot wrap around the planter. On the bottom, notches in the wings 8a & 8b hook onto the mesh to prevent unwanted movement of the planter. A small cutout in each wing 9 exists to facilitate installation. This relief cutout allows each wing to bend axially so the wings can clear the opening of the mesh when installed. FIG. 3 provides an isometric perspective on the planter in FIG. 2. Here the position of the hooks 8b can be seen relative to the flat panel atop the planter 7.

FIG. 4 depicts an embodiment of the planter in place within a mesh panel 2a. The top panel of the planter 7 sits atop the mesh 2a while the wings are woven below.

The notches on the planter wings 8a can be seen hooked onto the body of the mesh 2a. Here it is also shown that the planter body 4 fits within the cutouts of the mesh.

For situations where additional flotation is needed, FIG. 5 depicts the use of an additional part for added buoyancy. Here, a buoy of low-density material 13 is sandwiched between the planter panel 7 and the mesh body 2a. This both secures the buoy and provides flotation assistance for the planter. FIG. 6 provides a side view of this flotation assistance. Here, the planter wings 1 fan out on each side of the buoy 13, which sits atop the mesh body 2b.

One significant advantage of this design is the means by which many units may be grown in the same planters that are installed into the mesh body. FIG. 7 illustrates on such design that enables the simultaneous planting of multiple seedlings. In the depicted embodiment, 6 planters are produced as a single unit. Perforated seams 12 may connect the planters vertically while small joints may 11 connect the planters horizontally. By this method, individual planters 10 can be detached from the planter panel and installed into the mesh. However, during initial growing the combination of multiple units provides upright stability for the planting to take place. FIG. 8 details this collective stability.

Another major advantage of this design is the openness of the planters and mesh. The cutouts in each enable root networks of individual plants to comingle and to interweave in the material of the mesh. Since planters can be independently positioned about the mesh body it is possible to adjust the distance between planters to enhance or inhibit root intermingling 14. For instance, in situations where additional plant mass might be needed, planters could be positioned closer to one another. In situations where there is little rush for the plants to reach significant mass, greater spacing would might the overall cost of the operation and be preferred. In both situations, the roots of the plants are able to interweave and connect to the planters and the mesh providing a robust network of biofilters.

Information as herein shown and described in detail is fully capable of attaining the above-described object of the present disclosure, the presently preferred embodiment of the present disclosure; and is, thus, representative of the subject matter; which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

What is claimed is:

1. A planter made of a buoyant material, comprising:
a top surface;
a downward cavity extending from said top surface in the middle of said planter;
a base cavity in said downward cavity capable of holding enough soil for a plant disposed in said downward cavity to grow;
one or more cutouts in said downward cavity;
one or more winged extensions from said top surface capable of extending through a mesh below said top surface and attaching to said mesh from below.

2. The planter of claim 1, wherein said one or more winged extensions have some notches around their periphery for secure attachment to a mesh.

3. The planter of claim 1, wherein said one or more winged extensions have a small cutout to facilitate being bent axially for clearance of an opening in a mesh.

4. The planter of claim 1, further comprising a buoy below said top surface and around said downward cavity for additional buoyancy.

5. The planter of claim 1 attached to a similar planter with a perforated seam.

6. The planter of claim 1 attached to a similar planter with a small joint.

7. The planter of claim 1 detachably attached to similar planters in a tray arrangement.

8. The method of using the planter of claim 7, comprising:
filing said tray of planters with soil;
planting a plant in said soils of said planters in said tray.

9. The method of using the planters of claim 8, further comprising letting said plants sprout.

10. The method of using the planters of claim 8, further comprising attaching a planter from said tray to a mesh.

11. The method of using the planters of claim 8, further comprising attaching more than one of said planters from said tray to a mesh.

12. The planter of claim 1, further comprising a mesh.

13. The planter of claim 12, wherein said mesh is made of a buoyant material.

14. The planter of claim 12, wherein said mesh comprises hexagonal cutouts.

15. The planter of claim 1, further comprising soil disposed therein.

16. The planter of claim 1, further comprising a plant disposed therein.

17. The planter of claim 1, further comprising a plant capable of bioremediation.

18. The method of using the planter of claim 1, comprising:
filing said planter with soil;
planting a plant in said soil.

19. The method of using the planter of claim 18, further comprising letting said plant sprout.

20. The method of using the planter of claim 18, further comprising attaching said planter to a mesh.
